(19) United States
(12) Patent Application Publication
(10) Pub. No.: US 2010/0207905 A1
(43) Pub. Date: Aug. 19, 2010

(54) Method of Performing Timely Calibration of a Touch Parameter and Related Apparatus and System

(76) Inventors: Hui-Hung Chang, Keelung City (TW); Meng-Hsiu Wu, Hsinchu City (TW); Chun-Ching Huang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/553,980

(22) Filed: Sep. 3, 2009

(30) Foreign Application Priority Data
Feb. 18, 2009 (TW) 098105089

(51) Int. Cl. G06F 3/045

(52) U.S. Cl. 345/174

(57) ABSTRACT

A method of performing timely calibration of a touch parameter for a capacitive touch panel is disclosed. The method includes storing the touch parameter into a control register, sensing an analog touch signal according to the touch parameter stored in the control register and transforming the analog touch signal into a digital touch signal, reading the digital touch signal according to a calibrating read command, calculating a modified touch parameter according to the digital touch signal and transmitting the modified touch parameter to the capacitive touch panel, changing the touch parameter stored in a control register for the modified touch parameter according to a calibrating write command, determining an optimal touch parameter according to the digital touch signal sensed by using the modified touch parameter, and changing the touch parameter stored in a storage unit for the optimal touch parameter according to an updating write command.

### BACKGROUND OF THE INVENTION

1. Field of the Invention

The present invention relates to a method of performing timely calibration of a touch parameter and related apparatus and system, and more particularly, to a method capable of implementing timely calibration and update of the touch parameter without consuming additional resources of a storage unit and a micro control unit and related apparatus and system.

2. Description of the Prior Art

Touch panels are utilized widely in various consumer electronic products, such as personal digital assistants, personal computers, smart mobile phones, notebooks, and point of sale systems (POS), and offer advantages of convenient operation, rapid response speed, and economic use of space. Capacitive touch techniques having stable performance, excellent sensitivity and durability, making them some of the most popular touch techniques. The capacitive touch technique utilizes capacitive variations from static electricity generated by proximity or touch between the human body and the touch panel to achieve touch functions.

Please refer to FIG. 1. FIG. 1 is a schematic of a capacitive touch system 10 according to the prior art. The capacitive touch system 10 includes a sensing unit 102, a determination unit 104, and an application unit 106. The sensing unit 102 is utilized for transforming external environmental capacitance CAP_{E} and human body capacitance CAP_{H} into a readable digital signal. The determination unit 104 is coupled to the sensing unit 102 for determining a human body touch event according to the digital signal from the sensing unit 102, and informing the application unit 106 via a serial or parallel transmission interface so as to display corresponding effects. Therefore, as the human body (ex. a finger) touches the sensing unit 102, a corresponding analog signal is generated. The analog signal can be transformed into a digital signal to determine whether the human body has touched the capacitive touch system 10.

In general, the sensing unit 102 can set an environmental capacitance parameter for sensing the touching event in order to sense variations of the human body capacitance correctly. The environmental capacitance parameter is usually stored in a re-writable storage unit, such as an erasable programmable logic device (EEPLD), or a flash memory, in order to reload a predetermined environmental capacitance parameter during a reboot procedure. However, this type of method may result in an error in the sensing unit 102 due to environmental variance. For example, suppose the capacitive touch system 10 has an environmental capacitance parameter A before fabrication, and the sensing unit 102 also adjusts a corresponding environmental capacitance parameter. After the capacitive touch system 10 is fabricated on an integrated system (ex. a personal digital assistant), the corresponding environmental capacitance parameter may shift from A to B. In such a condition, the sensing unit 102 cannot sense variation of external human body capacitance accurately, thus the touch information can not be passed to the application unit 106 correctly. Therefore, for solving abnormal touch sensitivity resulting from environmental capacitance variation, the corresponding environmental capacitance parameter B should be reset for the sensing unit 102.

The prior art usually repeatedly modifies the environmental capacitance parameter of the sensing unit 102 by trial and error to obtain a proper environmental capacitance parameter for its current operating environment. However, the parameter stored in the storage unit needs to be modified each time the environmental capacitance parameter is modified. As a result, this a lot of time is wasted for test, and quantitative data cannot be obtained for optimal verification of the environmental capacitance parameter.

### SUMMARY OF THE INVENTION

It is therefore a primary objective of the claimed invention to provide a method capable of timely calibrating a touch parameter and related apparatus and system.

The present invention discloses a method of performing timely calibration of a touch parameter for a capacitive touch panel. The method includes storing the touch parameter into a control register; sensing an analog touch signal according to the touch parameter stored in the control register and transforming the analog touch signal into a digital touch signal; reading the digital touch signal according to a calibrating read command and transmitting the digital touch signal to a host control unit via a transmission interface; calculating a modified touch parameter according to the digital touch signal and transmitting the modified touch parameter to the capacitive touch panel; changing the touch parameter stored in a control register for the modified touch parameter according to a calibrating write command; determining an optimal touch parameter according to the digital touch signal sensed by using the modified touch parameter; and changing the touch parameter stored in a storage unit for the optimal touch parameter according to a updating write command.

The present invention further discloses a capacitive touch control apparatus for performing timely calibration of a touch parameter according to a control command through a transmission interface and a host control unit. The capacitive touch control apparatus includes an input/output interface coupled to the transmission interface for providing signals to and from the capacitive touch control apparatus; a control register for storing the touch parameter; a storage unit for storing an optimal touch parameter calculated by the host control unit; an analog to digital converter coupled to a sensing unit, the control register, and the storage unit for receiving an analog touch signal sensed by the sensing unit and transforming the analog touch signal into a digital touch signal; and an arbiter coupled to the control register, the storage unit, the analog to digital converter, and the input/output interface for receiving and decoding the control command, and arranging access to the control register, the storage unit, and the analog to digital converter according to the control command.

The present invention further discloses capacitive touch system for performing timely calibration of a touch parameter. The capacitive touch system includes a host control unit for generating a control command and calculating to calibrate an optimal touch parameter; a transmission interface coupled to the host control unit for bridging signals of various transmission formats; a sensing unit for sensing an analog touch signal according the touch parameter; and a capacitive touch control apparatus for timely calibrating and updating the touch parameter according to the control command via the transmission interface, which includes an input/output interface coupled to the transmission interface for providing signals to and from the capacitive touch control apparatus; a control register coupled to the sensing unit for storing the touch parameter; a storage unit coupled to the sensing unit for storing the optimal touch parameter; an analog to digital converter coupled to the sensing unit, the control register, and the storage unit for receiving the analog touch signal and transforming the analog touch signal into a digital touch signal; and an arbiter coupled to the control register, the storage unit, the analog to digital converter, and the input/output interface for receiving and decoding the control command, and arranging access to the control register, the storage unit, and the analog to digital converter according to the control command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic of a capacitive touch system according to the prior art.

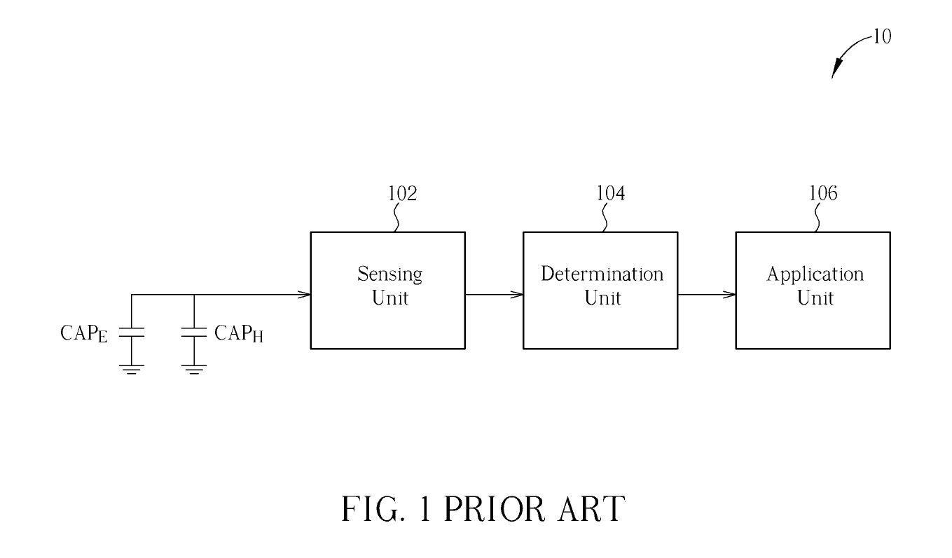

FIG. 2 is a schematic diagram of a capacitive touch system according to an embodiment of the invention.

FIG. 3 is a timely calibrating procedure for capacitive touch system according to an embodiment of the invention.

FIG. 4 is a schematic diagram of an arbiter according to an embodiment of the present invention.

FIG. 5 is a schematic diagram illustrating operation of calibrating read for arbiter according to an embodiment of the present invention.

FIG. 6 is a schematic diagram illustrating operation of calibrating write for arbiter according to an embodiment of the present invention.

FIG. 7 is a schematic diagram illustrating operation of updating write for arbiter according to an embodiment of the present invention.

FIG. 8 is a schematic diagram illustrating operation of updating read for arbiter according to an embodiment of the present invention.

### DETAILED DESCRIPTION

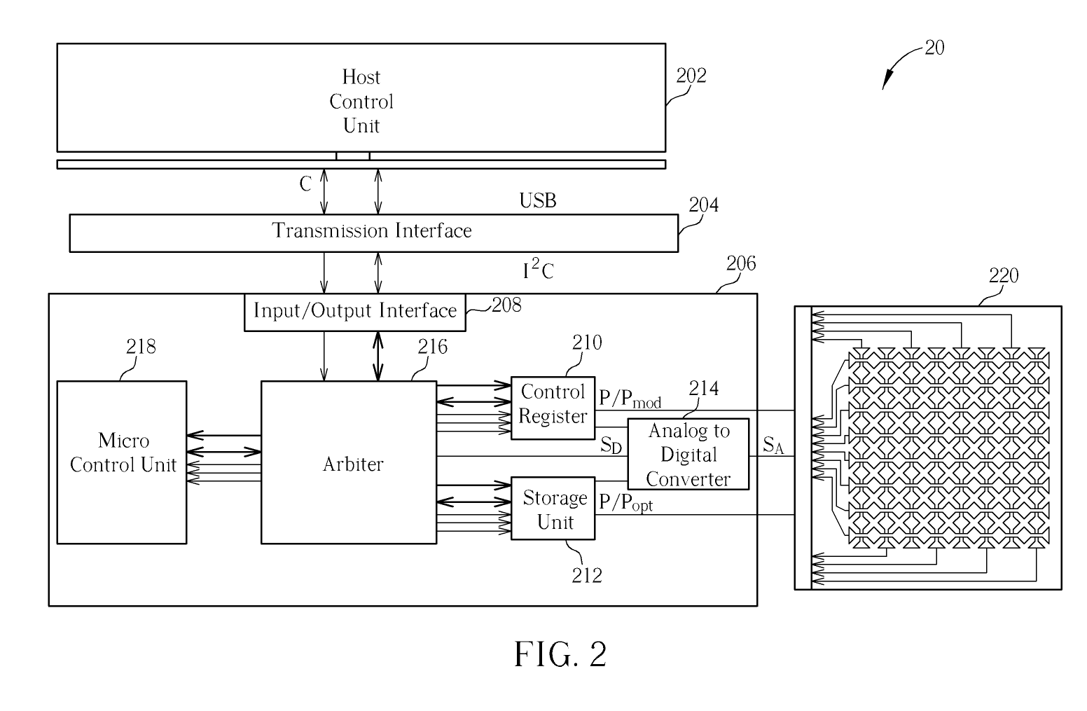

Please refer to FIG. 2. FIG. 2 is a schematic diagram of a capacitive touch system 20 according to an embodiment of the invention. The capacitive touch system 20 is utilized for performing timely calibration of a touch parameter P. The capacitive touch system 20 includes a host control unit 202, a transmission interface 204, a capacitive touch control apparatus 206, and a sensing unit 220. The host control unit 202 is utilized for generating a control command C and performing a calculation to calibrate an optimal touch parameter Pₒₚₜ. The transmission interface 204 is coupled to the host control unit 202 for bridging signals of various transmission formats. The sensing unit 220 is utilized for sensing an analog touch signal S_{A} generated by the human body touching the capacitive touch system 20 according to touch parameter P. The capacitive touch control apparatus 206 is utilized for timely calibration and updating the touch parameter P according to control command C via the transmission interface 204. The capacitive touch control apparatus 206 includes an input/output interface 208, a control register 210, a storage unit 212, an analog to digital converter 214, an arbiter 216, and a micro control unit 218. The input/output interface 208 is coupled to the transmission interface 204 for providing signals to and from the capacitive touch control apparatus 206. The control register 210 is coupled to the sensing unit 220 for storing the touch parameter P. The storage unit 212 is coupled to the sensing unit 220 for storing the optimal touch parameter Pₒₚₜ. The analog to digital converter 214 is coupled to the sensing unit 220, the control register 210, the storage unit 212, and the arbiter 216 for receiving analog touch signal S_{A} and transforming analog touch signal S_{A} into a digital touch signal S_{D}. The arbiter 216 is coupled to the control register 210, the storage unit 212, the analog to digital converter 214, the input/output interface 208, and the micro control unit 218 for receiving and decoding the control command C, and arranging access to the control register 210, the storage unit 212, and the analog to digital converter 214 according to the control command C. Preferably, the arbiter 216 is capable of decoding control command C (through hardware operation) to arrange to access data according to control command C. Preferably the control command C includes a calibrating read command C_{ISS}_{_{—}}_{R}, a calibrating write command C_{ISS}_{_{—}}_{W}, an updating read command C_{ISP}_{_{—}}_{R}, and an updating write command C_{ISP}_{_{—}}_{W}.

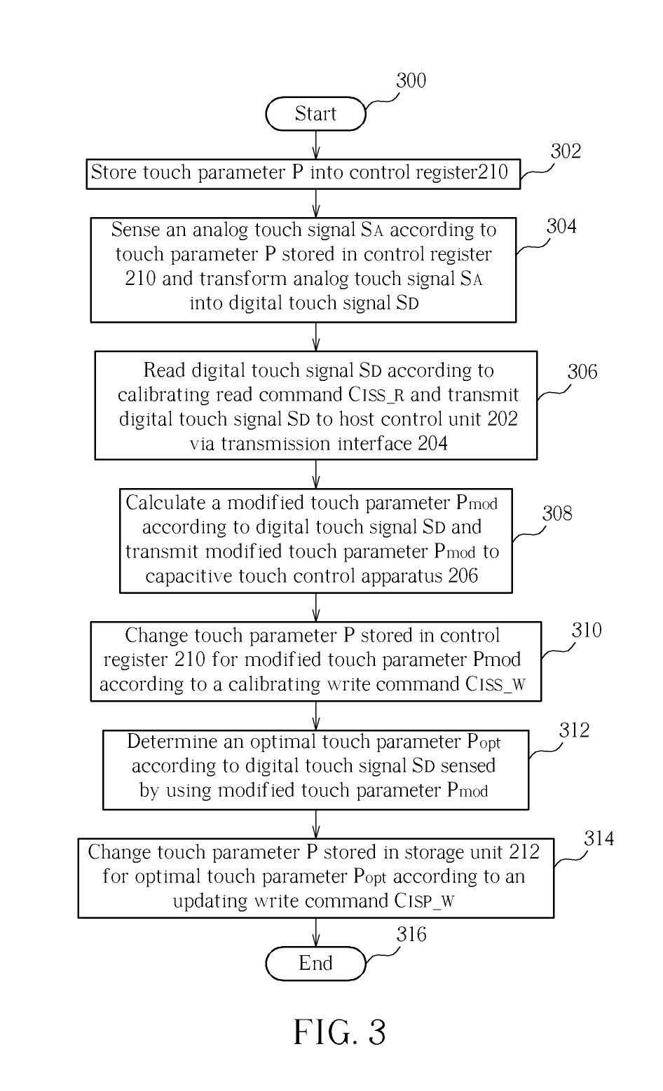

As to the implementation of the capacitive touch system 20, please refer to FIG. 3. FIG. 3 is a timely calibration procedure 30 for the capacitive touch system 20 according to an embodiment of the invention. The timely calibration procedure 30 is utilized for timely calibration and updating of the touch parameter P to the optimal touch parameter Pₒₚₜ. The procedure 30 comprises the following steps:

Step 300: Start.

Step 302: Store touch parameter P into control register 210.

Step 304: Sense an analog touch signal S_{A} according to touch parameter P stored in the control register 210 and transform analog touch signal S_{A} into digital touch signal S_{D}.

Step 306: Read digital touch signal S_{D} according to calibrating read command C_{ISS}_{_{—}}_{R} and transmit digital touch signal S_{D} to the host control unit 202 via the transmission interface 204.

Step 308: Calculate a modified touch parameter P_{mod} according to digital touch signal S_{D} and transmit modified touch parameter P_{mod} to the capacitive touch control apparatus 206.

Step 310: Change touch parameter P stored in the control register 210 for modified touch parameter P_{mod} according to a calibrating write command C_{ISS}_{_{—}}_{W}.

Step 312: Determine an optimal touch parameter Pₒₚₜ according to digital touch signal S_{D} sensed by using modified touch parameter P_{mod}.

Step 314: Change touch parameter P stored in the storage unit 212 for optimal touch parameter Pₒₚₜ according to an updating write command C_{ISP}_{_{—}}_{W}. Step 316: End.

According to procedure 30, the invention can set an optimal environmental capacitance parameter for a new environment. The capacitive touch control apparatus 206 can provide digital touch signal S_{D} transformed by the analog to digital converter 214 (according to touch parameter P) to the host control unit 202. After that, the host control unit 202 calculates a modified touch parameter P_{mod} and changes touch parameter P stored in the control register 210 for touch parameter P_{mod}. Thus, the sensing unit 220 continues to sense digital touch signal S_{D} according to modified touch parameter P_{mod}. The host control unit 202 can calculate an optimal touch parameter Pₒₚₜ according to the practical signals sensed by the sensing unit 220 with various modified touch parameter P_{mod}. In other words, the invention is capable of varying touch parameter P stored in the control register 210 until the optimal touch parameter Pₒₚₜ is obtained. As a result, the invention can achieve timely calibration functionality without wasting a lot of time to modify parameters in the storage unit. Furthermore, the optimal touch parameter Pₒₚₜ can be stored in the storage unit 212 according to updating write command C_{ISP}_{_{—}}_{W} to provide the sensing unit 220 an opportunity to sense a touching event in a new environment. In other words, the invention can directly store optimal touch parameter Pₒₚₜ to the storage unit 212 through the control command C which can be decoded by using the capacitive touch control apparatus 206, so as to achieve real-time update of the touch parameter P.

Besides, the analog to digital converter 214 can adjust a clock or a discharging resistor value for transforming the analog touch signal S_{A} into the digital touch signal S_{D} according to the touch parameter P. Therefore, after the touch parameter P stored in the control register 210 is replaced by the modified touch parameter P_{mod}, the analog to digital converter 214 adjusts the corresponding clock or discharging resistor value according to modified touch parameter P_{mod}. In addition, the host control unit 202 can determine the optimal touch parameter Pₒₚₜ by any method. For example, the host control unit 202 can determine optimal touch parameter Pₒₚₜ by analyzing maximum value, minimum value, or average value of variations of digital environmental capacitance among the digital touch signals S_{D}. Also, the host control unit 202 can determine optimal touch parameter Pₒₚₜ by analyzing maximum value, minimum value, or average value of the sum of variations of digital environmental capacitance and variations of digital human body capacitance among the digital touch signals S_{D}. Moreover, the host control unit 202 can determine optimal touch parameter Pₒₚₜ by analyzing maximum value, minimum value, or average value of the difference between variations of digital environmental capacitance and variations of digital human body capacitance among the digital touch signals S_{D}. For example, the circuit designer can set the system to where optimal touch parameter Pₒₚₜ is obtained when the difference between variations of digital environmental capacitance and variations of digital human body capacitance is within a preferred operating range of a microprocessor.

In short, the capacitive touch system 20 is capable of varying touch parameter P stored in the control register 210 until the optimal touch parameter Pₒₚₜ is obtained. Therefore, the invention can achieve timely setting functionality without wasting a lot of time to modify parameters in the storage. Moreover, the optimal touch parameter Pₒₚₜ can be stored in the storage unit 212 according to updating read command C_{ISP}_{_{—}}_{R}, so that the sensing unit 220 can sense a touching event in a new environment. As a result, the invention can overcome abnormal touch sensitivity resulting from environmental capacitance variation. In addition, the host control unit 202 performs digital operations and comparison for rapidly updating an optimal capacitance parameter, and all of the data obtained during test can be saved for later quantitative analysis.

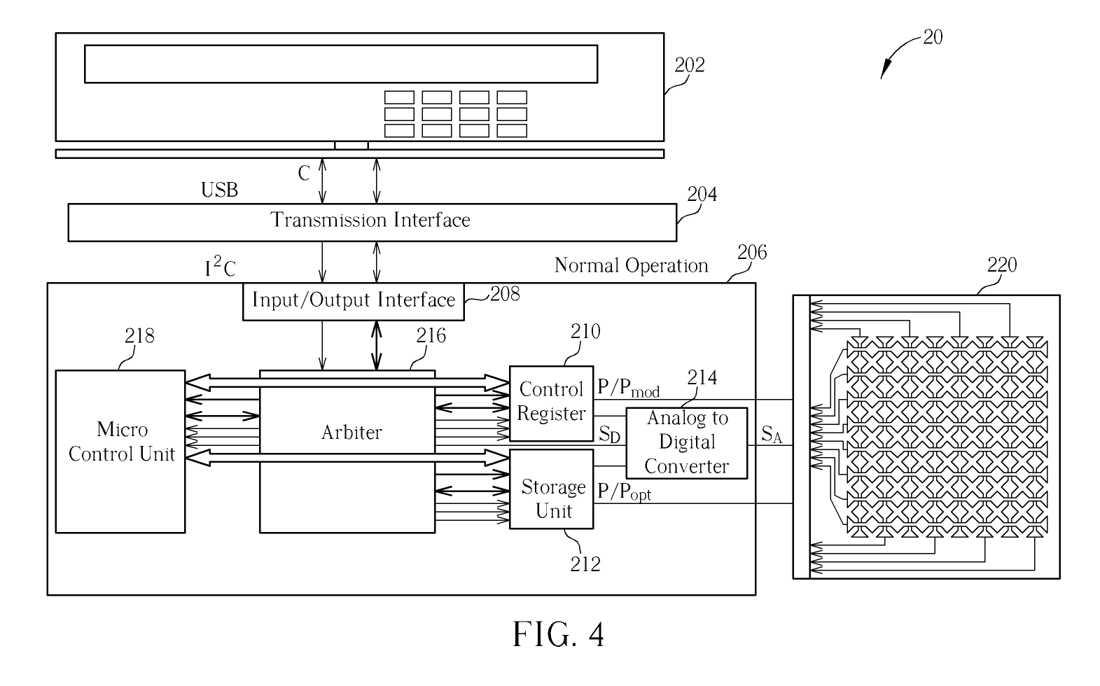

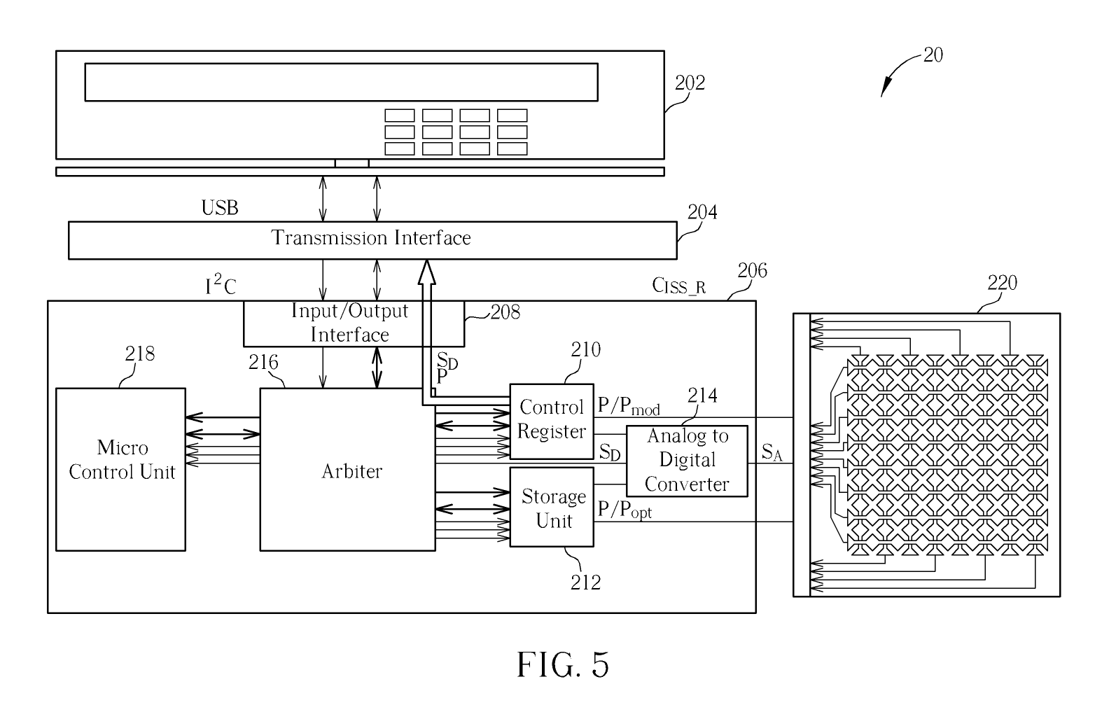

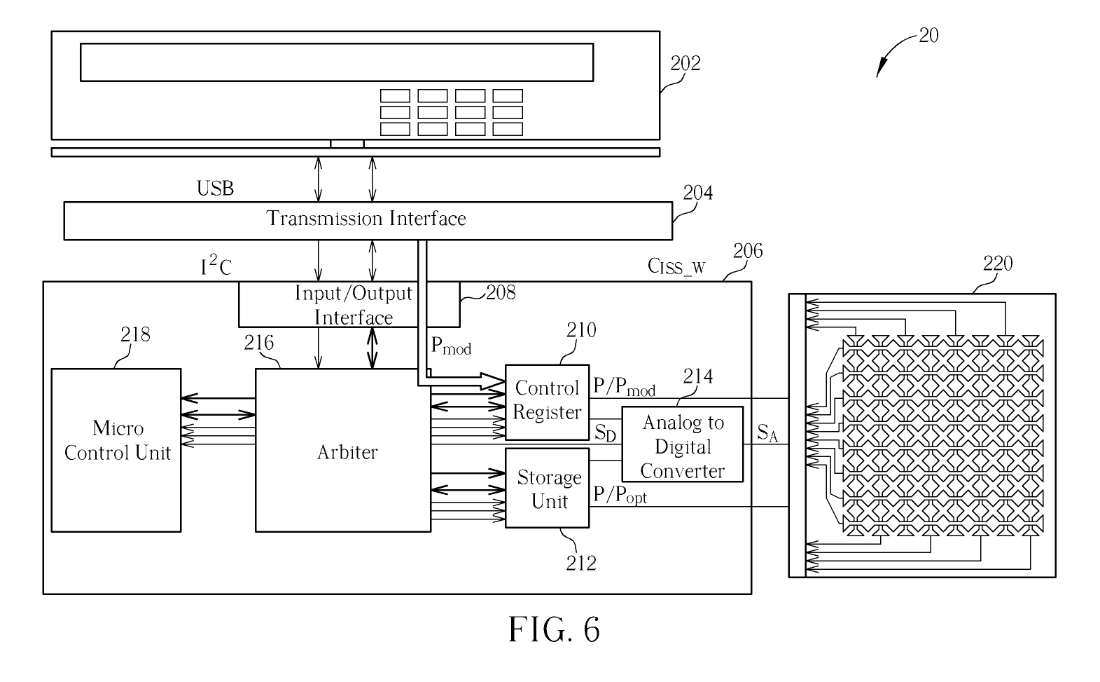

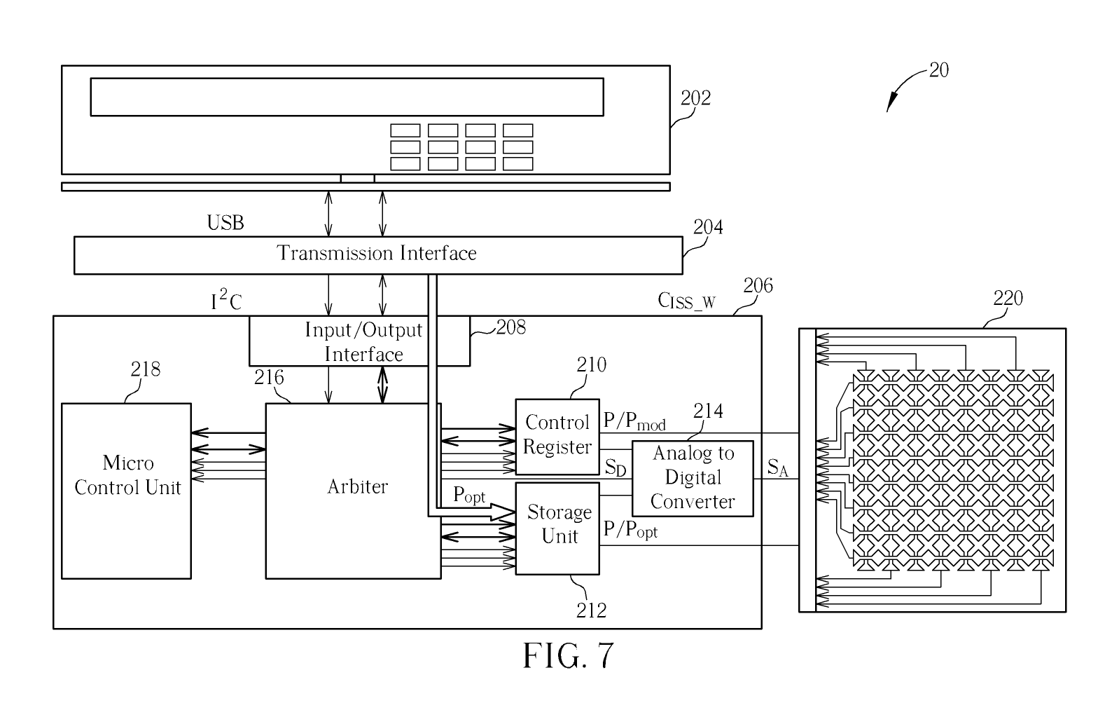

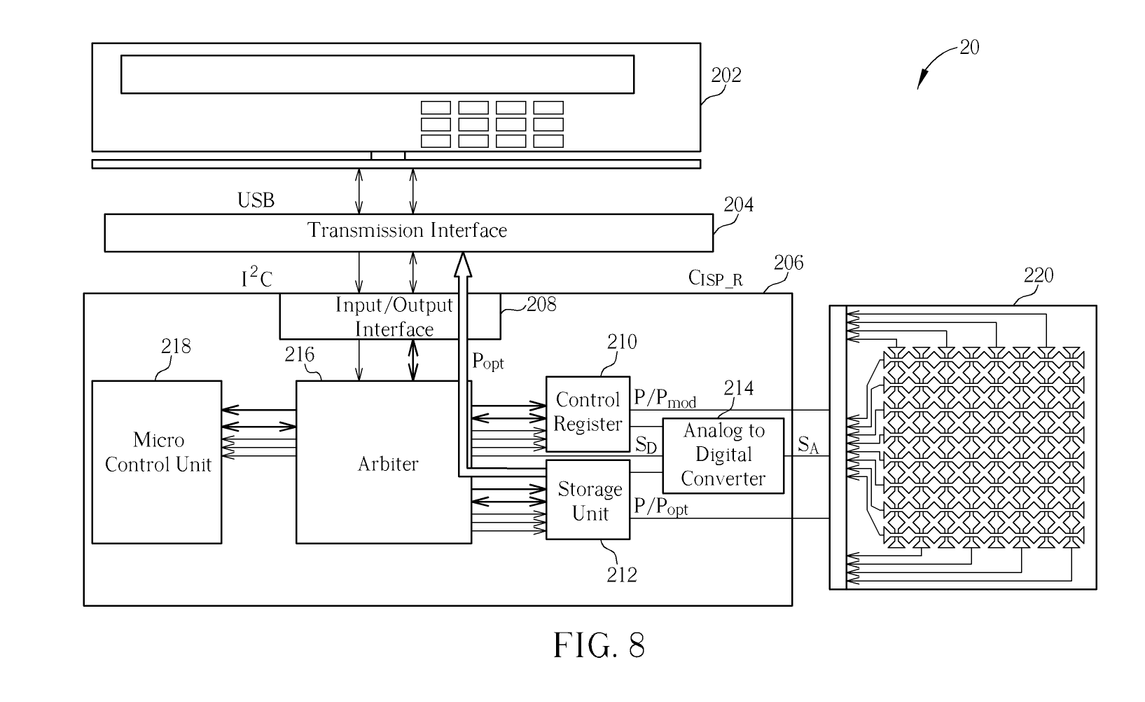

Furthermore, please refer to FIG. 4. FIG. 4 is a schematic diagram of the arbiter 216 according to an embodiment of the present invention. As shown in FIG. 4, in the capacitive touch control apparatus 206, the micro control unit 218 can read data or programs stored in the storage unit 212 through the arbiter 216, and read/write either touch parameter P of the control register 210 or digital touch signals S_{D} of the analog to digital converter 214 according to the read programs. Again, please refer to FIG. 5, FIG. 5 is a schematic diagram illustrating the calibrating read operation for the arbiter 216 according to an embodiment of the present invention. When the arbiter 216 receives and decodes the calibrating read command C_{ISS}_{_{—}}_{R} via the transmission interface 204, the arbiter 216 will control reading of digital touch signal S_{D} or touch parameter P according to the calibrating read command C_{ISS}_{_{—}}_{R}. Please refer to FIG. 6, which is a schematic diagram illustrating the calibrating write operation for the arbiter 216 according to an embodiment of the present invention. The host control unit 202 calculates a proper modified touch parameter P_{mod} according to touch parameter P or digital touch signals S_{D}, and transmits modified touch parameter P_{mod} and calibrating write command C_{ISS}_{_{—}}_{W} to the arbiter 216 via the transmission interface 204. After the arbiter 216 receives and decodes the calibrating write command C_{ISS}_{_{—}}_{W}, the arbiter 216 arranges to write the modified touch parameter P_{mod} to the control register 210 according to calibrating write command C_{ISS}_{_{—}}_{W}, so that touch parameter P stored in the control register 210 will be replaced by modified touch parameter P_{mod} Please further refer to FIG. 7, which is a schematic diagram illustrating an updating write operation for the arbiter 216 according to an embodiment of the present invention. The host control unit 202 calculates optimal touch parameter Pₒₚₜ according to the practical signals sensed by the sensing unit 220 with various modified touch parameters P_{mod}. After that, the host control unit 202 transmits optimal touch parameter Pₒₚₜ and updating write command C_{ISP}_{_{—}}_{W} to the arbiter 216. When the arbiter 216 receives and decodes the updating write command C_{ISP}_{_{—}}_{W}, the arbiter 216 will control writing of the optimal touch parameter Pₒₚₜ to the storage unit 212 according to the updating write command C_{ISP}_{_{—}}_{W}, so that touch parameter P stored in the storage unit 212 will be replaced by optimal touch parameter Pₒₚₜ. In addition, please refer to FIG. 8, which is a schematic diagram illustrating an updating read operation for the arbiter 216 according to an embodiment of the present invention. The host control unit 202 can generate updating read command C_{ISP}_{_{—}}_{R}, and transmits updating read command C_{ISP}_{_{—}}_{R} to the arbiter 216. When the arbiter 216 receives and decodes the calibrating read command C_{ISP}_{_{—}}_{R}, the arbiter 216 will arrange to read touch parameter P or optimal touch parameter Pₒₚₜ from the storage unit 212 according to the updating read command C_{ISP}_{_{—}}_{R}. In other words, the invention can implement related processes directly through decoding the commands by hardware without using additional program and storage units, so that the invention may avoid consuming resources of the micro control unit 218. Therefore, the invention can reduce load of the storage unit and complexity of an implementation program, and complete timely calibration and updating functions rapidly.

Note that embodiments of the capacitive touch system 20 are exemplary embodiments of the present invention, and those skilled in the art can make alternations and modifications accordingly. For example, any kind of operating apparatus or application software which can analyze maximum value, minimum value, average value, or difference value of variations of digital capacitance independently, display digital signals, and generate timely calibration and updating commands is suitable for the host control unit 202, such as a computer, or a micro control unit having an input/output interface. Preferably, the host control unit 202 further includes a storage unit for storage of variation values of digital capacitance sensed during calibration for later calculation and analysis. On the other hand, the transmission interface 204 is utilized for bridging signals of various transmission formats. As shown in FIG. 2, while the host control unit 202 transmits signals through a universal serial bus (USB) interface, and the input/output interface 208 of the capacitive touch control apparatus 206 uses an inter-IC Bus (I²C Bus), the transmission interface 204 can transform signals into a corresponding format. For example, the host control unit 202 transmits specific signal packets complying with the USB interface via the transmission interface 204 for representing updating write command C_{ISP}_{_{—}}_{W}. The specific signal packets can be transformed into I²C interface form by the transmission interface 204 and transmitted to the arbiter 216. After that, the arbiter 216 decodes the signal packets complying with I²C interface format to generate the related control signal, and writes data, such as optimal touch parameter Pₒₚₜ, to the storage unit 212. Thus, transmission among the host control unit 202, the transmission unit 204, and the capacitive touch control apparatus 206 may be performed through any serial transmission mode, such as I²C Bus interface, USB interface, serial peripheral interface (SPI) interface, universal asynchronous receiver transmitter (UART) interface, etc., any parallel transmission mode, such as integrated drive electronics (IDE), small computer system interface (SCSI), etc., or any wireless transmission mode, such as infrared (IR), Bluetooth, or IEEE 802.11, etc. In addition, the storage unit 212 can be any multiple re-writable storage apparatus, such as an electrically erasable programmable logic device (EEPLD), flash memory, etc. On the other hand, while the capacitive touch system 20 is in touch parameter timely calibration/updating mode, both the sensing unit 220 and the analog to digital converter 214 can realize operation processes according to touch parameter P stored in the control register 210 (not to be changed for modified touch parameter P_{mod}) or modified touch parameter P_{mod}. Otherwise, while the capacitive touch system 20 is in general touch sensing mode, both the sensing unit 220 and the analog to digital converter 214 can realize operation processes according to optimal touch parameter Pₒₚₜ stored in the storage unit 212.

In summary, the invention is capable of performing digital operations and comparison for rapidly updating optimal capacitance parameter and all of the data during testing can be saved for later quantitative analysis. Furthermore, the invention can directly store touch parameter in the control register through the control command C which can be decoded by the capacitive touch control apparatus for providing the sensing unit an opportunity to sense a touch event in a new environment. Thus, the invention can achieve timely calibration functionality without wasting a lot of time to modify parameters in the storage unit. Meanwhile, the optimal touch parameter can also be stored in storage unit directly for real-time update. As a result, the invention may avoid consumption of resources of the micro control unit of the capacitive touch control apparatus, reducing loading of the storage unit and complexity of the implementation program, and rapidly realizing timely calibration and updating functions.

Those skilled in the art will readily observe that numerous modifications and alterations of the device and method may be made while retaining the teachings of the invention.

What is claimed is:

1. A method of performing timely calibration of a touch parameter for a capacitive touch panel, the method comprising:
storing the touch parameter in a control register;
sensing an analog touch signal according to the touch parameter stored in the control register, and transforming the analog touch signal into a digital touch signal;
reading the digital touch signal according to a calibrating read command, and transmitting the digital touch signal to a host control unit via a transmission interface;
calculating a modified touch parameter according to the digital touch signal and transmitting the modified touch parameter to the capacitive touch panel;
changing the touch parameter stored in the control register for the modified touch parameter according to a calibrating write command;
determining an optimal touch parameter according to the digital touch signal sensed by using the modified touch parameter; and
changing the touch parameter stored in a storage unit for the optimal touch parameter according to an updating write command.

2. The method of claim 1, wherein the step of determining the optimal touch parameter according to the digital touch signal comprises:
calculating maximum value, minimum value, or average value of variations of digital environmental capacitance among the digital touch signals to determine the optimal touch parameter.

3. The method of claim 1, wherein the step of determining the optimal touch parameter according to the digital touch signal sensed comprises:
calculating maximum value, minimum value, or average value of the sum of variations of digital environmental capacitance and variations of digital human body capacitance among the digital touch signals to determine the optimal touch parameter.

4. The method of claim 1, wherein the step of determining the optimal touch parameter according to the digital touch signal comprises:
calculating maximum value, minimum value, or average value of the difference between variations of digital environmental capacitance and variations of digital human body capacitance among the digital touch signals to determine the optimal touch parameter.

5. A capacitive touch control apparatus for performing timely calibration of a touch parameter according to a control command through a transmission interface and a host control unit, the capacitive touch control apparatus comprising:
an input/output interface coupled to the transmission interface for providing signals to and from the capacitive touch control apparatus;
a control register for storing the touch parameter;
a storage unit for storing an optimal touch parameter calculated by the host control unit;
an analog to digital converter coupled to a sensing unit, the control register, and the storage unit for receiving an analog touch signal sensed by the sensing unit and transforming the analog touch signal into a digital touch signal; and
an arbiter coupled to the control register, the storage unit, the analog to digital converter, and the input/output interface for receiving and decoding the control command, and arranging access to the control register, the storage unit, and the analog to digital converter according to the control command.

6. The capacitive touch control apparatus of claim 5, wherein the analog to digital converter adjusts a clock for transforming the analog touch signal into the digital touch signal according to the touch parameter.

7. The capacitive touch control apparatus of claim 5, wherein the analog to digital converter adjusts a discharging resistor value for transforming the analog touch signal into the digital touch signal according to the touch parameter.

8. The capacitive touch control apparatus of claim 5, wherein the control command comprises a calibrating read command, a calibrating write command, an updating read command, and an updating write command.

9. The capacitive touch control apparatus of claim 8, wherein the control command is generated by the host control unit.

10. The capacitive touch control apparatus of claim 8, wherein the arbiter reads the digital touch signal according to the calibrating read command and transmits the digital touch signal to the host control unit via the transmission interface after the arbiter receives and decodes the calibrating read command.

11. The capacitive touch control apparatus of claim 10, wherein the host control unit calculates a modified touch parameter according to the digital touch signal, and transmits the modified touch parameter and a calibrating write command to the arbiter via the transmission interface.

12. The capacitive touch control apparatus of claim 11, wherein the arbiter arranges to store the modified touch parameter into the control register to change the touch parameter stored in the control register for the modified touch parameter according to the calibrating write command after the arbiter receives and decodes the calibrating write command.

13. The capacitive touch control apparatus of claim 12, wherein the host control unit transmits the optimal touch parameter and an updating write command to the arbiter via the transmission interface after determining the optimal touch parameter according to the digital touch signal sensed by using the modified touch parameter.

14. The capacitive touch control apparatus of claim 13, wherein the arbiter arranges to store the optimal touch parameter into the storage unit to change the touch parameter stored in the storage unit for the optimal touch parameter according to the updating write command after the arbiter receives and decodes the updating write command.

15. A capacitive touch system for performing timely calibration of a touch parameter, the capacitive touch system comprising:
a host control unit for generating a control command and performing a calculation to calibrate an optimal touch parameter;
a transmission interface coupled to the host control unit for bridging signals of various transmission formats;
a sensing unit for sensing an analog touch signal according the touch parameter; and
a capacitive touch control apparatus for performing timely calibration and update of the touch parameter according to the control command via the transmission interface, the capacitive touch control apparatus comprising:
an input/output interface coupled to the transmission interface for providing signals to and from the capacitive touch control apparatus;
a control register coupled to the sensing unit for storing the touch parameter;
a storage unit coupled to the sensing unit for storing the optimal touch parameter;
an analog to digital converter coupled to the sensing unit, the control register, and the storage unit for receiving the analog touch signal and transforming the analog touch signal into a digital touch signal; and
an arbiter coupled to the control register, the storage unit, the analog to digital converter, and the input/output interface for receiving and decoding the control command, and arranging access to the control register, the storage unit, and the analog to digital converter according to the control command.

16. The capacitive touch system of claim 15, wherein the analog to digital converter adjusts a clock for transforming the analog touch signal into the digital touch signal according to the touch parameter.

17. The capacitive touch system of claim 15, wherein the analog to digital converter adjusts a discharging resistor value for transforming the analog touch signal into the digital touch signal according to the touch parameter.

18. The capacitive touch system of claim 15, wherein the host control unit calculates maximum value, minimum value, or average value of variations of digital environmental capacitance among the digital touch signals to determine the optimal touch parameter.

19. The capacitive touch system of claim 15, wherein the host control unit calculates maximum value, minimum value, or average value of the sum of variations of digital environmental capacitance and variations of digital human body capacitance among the digital touch signals to determine the optimal touch parameter.

20. The capacitive touch system of claim 15, wherein the host control unit calculates maximum value, minimum value, or average value of the difference between variations of digital environmental capacitance and variations of digital human body capacitance among the digital touch signals to determine the optimal touch parameter.

21. The capacitive touch system of claim 15, wherein the control command comprises a calibrating read command, a calibrating write command, an updating read command, and an updating write command.

22. The capacitive touch system of claim 21, wherein the arbiter reads the digital touch signal according to the calibrating read command and transmits the digital touch signal to the host control unit via the transmission interface after the arbiter receives and decodes the calibrating read command.

23. The capacitive touch system of claim 22, wherein the host control unit calculates a modified touch parameter according to the digital touch signal and transmits the modified touch parameter and a calibrating write command to the arbiter via the transmission interface.

24. The capacitive touch system of claim 23, wherein the arbiter arranges to store the modified touch parameter into the control register to change the touch parameter stored in the control register for the modified touch parameter according to the calibrating write command after the arbiter receives and decodes the calibrating write command.

25. The capacitive touch system of claim 24, wherein the host control unit transmits the optimal touch parameter and an updating write command to the arbiter via the transmission interface after determining the optimal touch parameter according to the digital touch signal sensed by using the modified touch parameter.

26. The capacitive touch system of claim 25, wherein the arbiter arranges to store the optimal touch parameter into the storage unit to change the touch parameter stored in the storage unit for the optimal touch parameter according to the updating write command after the arbiter receives and decodes the updating write command.
